(19) United States
(12) Patent Application Publication
(10) Pub. No.: US 2012/0075167 A1
(43) Pub. Date: Mar. 29, 2012

(54) HEAD-MOUNTED DISPLAY WITH WIRELESS CONTROLLER

(75) Inventors: Tomi Lahcanski, Rochester, NY (US); Lawrence B. Landry, Victor, NY (US); Ronald S. Cok, Rochester, NY (US)

(73) Assignee: Eastman Kodak Company

(21) Appl. No.: 12/893,092

(22) Filed: Sep. 29, 2010

(51) Int. Cl. G09G 5/00

(52) U.S. Cl. 345/8

(57) ABSTRACT

A head-mounted display apparatus includes a head-mounted display, the head-mounted display including a viewing area that displays information to a user of the head-mounted display and including a display wireless communication circuit for receiving wireless control signals and a controller including a controller wireless communication circuit, wherein the controller controls the information displayed in the head-mounted display by communicating the wireless control signals to the display wireless communication circuit with the controller wireless communication circuit and wherein the controller is physically separate from the head-mounted display. A distance-monitoring circuit in the controller or the head-mounted display monitors the distance between the controller and the head-mounted display and, when the distance between the controller and the head-mounted display is greater than a pre-determined distance, initiating a range signal to the user.

### CROSS REFERENCE TO RELATED APPLICATIONS

Reference is made to commonly assigned U.S. patent application Ser. No. 12/862,994, filed Aug. 25, 2010, entitled Switchable Head-Mounted Display, to John N. Border, et al, the disclosure of which is incorporated herein.

### FIELD OF THE INVENTION

The present invention relates to a head-mounted display apparatus. More particularly, the present invention relates to a head-mounted display apparatus having a wireless controller that is physically detached from a head-mounted display

### BACKGROUND OF THE INVENTION

Head-mounted displays are widely used in gaming and training applications. Such head-mounted displays typically use electronically controlled displays mounted on a pair of glasses or a helmet with supporting structures such as ear, neck, or head pieces that are worn on a user's head. Displays are built into the glasses together with suitable optics to present electronic imagery to a user's eyes.

Most head-mounted displays provide an immersive effect in which scenes from the real world are obscured and the user can see, or is intended to see, only the imagery presented by the displays. Immersive displays can include cameras to capture images of the scene in front of the user so that this image information can be combined with other images to provide a combined image of the scene where portions of the scene image have been replaced to create a virtual image of the scene. In such an arrangement, the display area is opaque. Such displays are commercially available, for example from Vuzix Corporation.

Alternatively, some head-mounted displays provide a see-through display for an augmented-reality view in which real-world scenes are visible to a user but additional image information is overlaid on the real-world scenes. Such an augmented-reality view is provided by helmet-mounted displays found in military applications and by heads-up displays (HUDs) in the windshields of automobiles. In this case, the display area is transparent. FIG. 1 shows a typical prior-art head-mounted display 10 that is a see-through display in a glasses format. The head-mounted display 10 includes: ear pieces 14 to locate the device on the user's head; lens areas 12 that have variable occlusion members 7; microprojectors 8 and control electronics 9 to provide images to at least the variable occlusion members 7.

U.S. Pat. No. 6,829,095 describes a device with the head-mounted display 10 or augmented-reality display in a glasses format where image information is presented within the lens areas 12 of the glasses. The lens areas 12 of the glasses in this patent include waveguides to carry the image information to be displayed from an image source, with a built-in array of partially reflective surfaces to reflect the information out of the waveguide in the direction of the user's eyes. FIG. 2 shows a schematic diagram of a cross-section of the lens area 12 including: a waveguide 13; partial reflectors 3 along with; the microprojector 8 to supply a digital image; light rays 4 passing from the microprojector 8, through the waveguide 13, partially reflecting off the partial reflectors 3, and continuing on to the user's eye 2. As is seen in FIG. 2, light rays 5 from the ambient environment pass through the variable occlusion member 7, the waveguide 13 and partial reflectors 3 as well as the transparent surrounding area of the lens area 12 to combine with the light rays 4 from the microprojector 8 and continue on to the user's eye 2 to form a combined image.

It is important that head-mounted displays be portable and comfortable for users. Generally, a light weight and a small form factor are critical factors for user comfort. To enable a light-weight and a small form factor, it is helpful to reduce the size and weight of the various elements that make up the head-mounted display, including the control electronics and any power needed to drive the control electronics. There is a need, therefore, for an improved head-mounted display apparatus that reduces the physical size and weight of the head-mounted display.

### SUMMARY OF THE INVENTION

In accordance with the present invention, there is provided a head-mounted display apparatus, comprising:

a head-mounted display, the head-mounted display including a viewing area that displays information to a user of the head-mounted display and including a display wireless communication circuit for receiving wireless control signals;

a controller including a controller wireless communication circuit, wherein the controller controls the information displayed in the head-mounted display by communicating the wireless control signals to the display wireless communication circuit with the controller wireless communication circuit and wherein the controller is physically separate from the head-mounted display; and

a distance-monitoring circuit in the controller or the head-mounted display that monitors the distance between the controller and the head-mounted display and, when the distance between the controller and the head-mounted display is greater than a pre-determined distance, initiating a range signal to the user.

In another aspect of the present invention, a head-mounted display apparatus, comprises:

a head-mounted display, the head-mounted display including a viewing area that displays information to a user of the head-mounted display and including a display wireless communication circuit for receiving wireless control signals; and

a controller physically separate from the head-mounted display and a controller wireless communication circuit, wherein the controller controls the information displayed in the head-mounted display by causing the wireless control signals to communicate from the control wireless communication circuit to the display wireless communication circuit

An important feature of the present invention, by having a head-mounted display having a physically separate controller, a more comfortable and efficient head-mounted display is provided and a head-mounted display device is responsive to different controllers in different locations thereby improving the versatility and utility of the head-mounted display.

### BRIEF DESCRIPTION OF THE DRAWINGS

The above and other objects, features, and advantages of the present invention will become more apparent when taken in conjunction with the following description and drawings, wherein identical reference numerals have been used, where possible, to designate identical features that are common to the figures, and wherein:

FIG. 1 is an illustration of a prior-art heads-up display with a variable occlusion member in a transparent state;

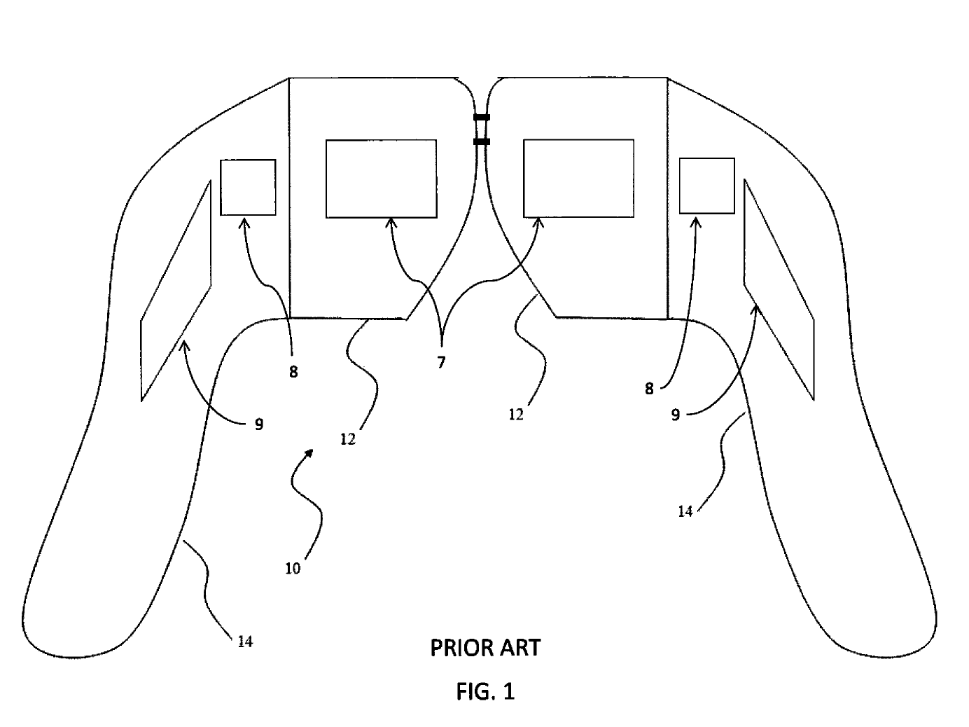

FIG. 2 is a schematic of a cross-section of a prior-art lens area of the heads-up display and the associated light from the microprojector and from the ambient environment with a variable occlusion member in a transparent state;

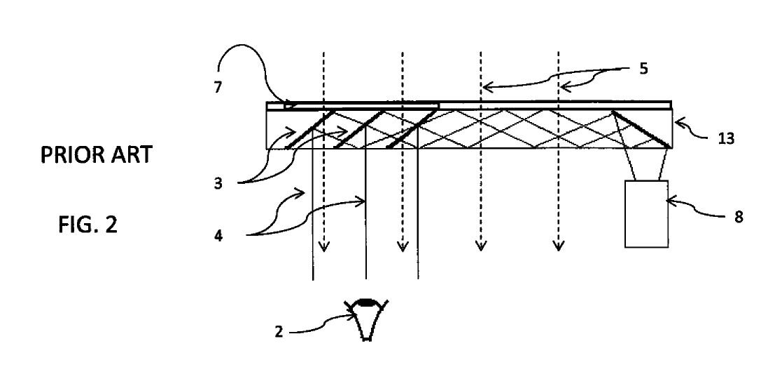

FIG. 3 is an illustration of a heads-up display apparatus according to an embodiment of the present invention; and

FIG. 4 is an illustration of a heads-up display system according to an embodiment of the present invention.

### DETAILED DESCRIPTION OF THE INVENTION

A wide variety of head-mounted displays are known in the art. The head-mounted displays include a microprojector or image scanner to provide image information, relay optics to focus and transport the light of the image information to the display device and a display device that is viewable by the user's eyes. Head-mounted displays can provide image information to one eye of the user or both eyes of the user. Head-mounted displays that present image information to both eyes of the user can have one or two microprojectors. Monoscopic viewing, in which the same image information is presented to both eyes, is done with head-mounted displays that have one or two microprojectors. Stereoscopic viewing typically requires a head-mounted display that has two microprojectors.

The microprojectors include image sources to provide the image information to the head-mounted display. A variety of image sources are known in the art including, for example, organic light-emitting diode (OLED) displays, liquid crystal displays (LCDs), or liquid crystal on silicon (LCOS) displays.

The relay optics can include refractive lenses, reflective lenses, diffractive lenses, holographic lenses or waveguides. For a see-through display, the display should permit at least a partial view of the ambient environment or scene outside the head-mounted display within the user's line of sight. Suitable displays known in the art in which a digital image is presented for viewing by a user include a device or surface including waveguides, polarized reflecting surfaces, partially reflecting surfaces, or switchable mirrors. The present invention concerns display devices that are useable as see-through displays and that are useable to present information to a user.

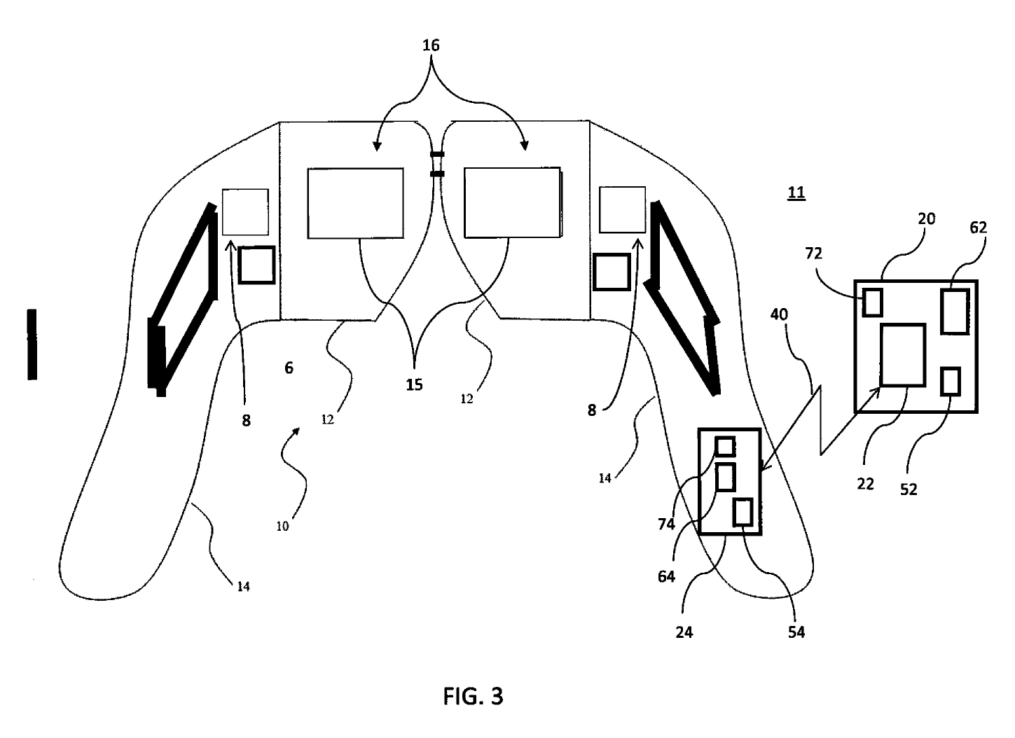

Referring to FIG. 3, according to an aspect of the present invention, a head-mounted display apparatus 11 includes a head-mounted display 10 and a physically separate controller 20. A physically separate controller 20, as used herein is a controller that is not mounted on the head-mounted display 10 nor has any wired connections to the head-mounted display 10. The head-mounted display 10 includes a viewing area or viewing areas 15 that display information to a user of the head-mounted display apparatus 11. The head-mounted display 10 can include microprojectors 8 to present information on to the viewing areas 15, for example images that are viewed by the head-mounted display user and ear pieces 14 to locate the device on the user's head. The physically separate controller 20 controls the information presented to the user in the viewing area 15 of the head-mounted display 10. In an embodiment of the present invention, the head-mounted display 10 is worn by a user on the user's head while the controller 20 is worn elsewhere on the user's body, for example on a belt at the waist, on the back in a pack, on the chest, or in clothing pockets. In another embodiment, the controller 20 is located separately from the user, for example in the same room as the user, in a desk, drawer, or with other furniture items in a room. Controllers can include digital or analog electronic circuitry known in the computing and electronic arts.

The head-mounted display 10 includes a display wireless communication circuit 24 for receiving wireless control signals through a wireless communication channel 40 communicated from a controller wireless communication circuit 22 located in the controller 20. The controller 20 communicates information through controller wireless communication circuit 22 to the display wireless communication circuit 24 in the head-mounted display 10 to present information to the user. Wireless communication is enabled by a variety of technologies, including point-to-point radio communications, networked wireless communications such as WiFi, or other standard wireless communication methods such as Bluetooth.

The controller 20 can also be implemented as one component of another system, which is enabled to communicate with the head-mounted display 10 to integrate control of the head-mounted display 10 into the natural control mechanisms of the other system, for example steering-wheel-mounted controls in an automobile or other vehicle. Such a controller is integrated into large items or much smaller items limited only by the physical size required for the controller 20.

Because the head-mounted display 10 and the controller 20 are physically separate, they can become disassociated, i.e. one of the two elements is lost or separated from the other such that communication between them is not possible. To assist in preventing this eventuality, in another aspect of the present invention, a distance-monitoring circuit 52, 54 is located in the controller 20 or the head-mounted display 10, respectively, or both, that monitors the distance between the controller 20 and the head-mounted display 10 and, when the distance between the controller 20 and the head-mounted display 10 is greater than a pre-determined distance, initiates a range signal to the user. In another embodiment, the distance-monitoring circuits 52, 54 are included in the display wireless communication circuit 24, the controller wireless communication circuit 22, or both the display wireless communication circuit 24 and the controller wireless communication circuit 22. The distance-monitoring circuits 52, 54 can have mutually cooperative circuits.

In various embodiments of the present invention, the distance-monitoring circuits 52, 54 can include one or more of a variety of arrangements to monitor the distance between the controller 20 and the head-mounted display 10. In one embodiment, the distance-monitoring circuit measures a propagation delay for a wireless signal to be communicated from the controller 20 to the head-mounted display 10 or from the head-mounted display 10 to the controller 20. The distance-monitoring circuit can measure a propagation delay for a wireless signal to be communicated from the controller 20 to the head-mounted display 10 and back or from the head-mounted display 10 to the controller 20 and back. The elapsed time (subtracting any computational and circuit overhead) is indicative of the distance, since electromagnetic signals travel at approximately one foot per nanosecond. Circuits are known that enable measurements and switching times of substantially less than one nanosecond.

In an alternative embodiment of the present invention, the distance monitoring circuits 52, 54 include a global positioning satellite (GPS) unit. By locating a global positioning satellite unit 72 in the controller 20 and a global positioning satellite unit 74 in the head-mounted display 10, the positions of the controller 20 and the head-mounted display 10 can be determined and a comparison of the position of the controller 20 and the position of the head-mounted display 10 made. Thus, the relative distance between the controller 20 and the head-mounted display 10 can be found, within the accuracy of the GPS circuits and satellites. Circuitry for finding the distance between two positions is within the capability of those knowledgeable in the computing arts and can include, for example, comparative circuits, digital logic, and the like.

In yet another embodiment of the present invention, the distance-monitoring circuitry initiates a range signal when the controller 20 fails to communicate with the head-mounted display 10 or the head-mounted display 10 fails to communicate with the controller 20 when desired. In one embodiment, a point-to-point low-power, local electromagnetic transmission is used. When the distance between the controller and the head-mounted display is too great, the signal has too low a power and communication cannot occur, as is found for example in devices employing the Bluetooth standard. In an embodiment of the present invention, the controller 20 and the head-mounted display 10 periodically communicate with each other sending a ‘heartbeat’ signal to ensure mutual presence. The distance-monitoring circuitry initiates a range signal when it fails to receive some number of heartbeat signals in a row. The actual number used for various heartbeat systems can vary based on the reliability of the signal and the expected interference that can cause temporary failures to receive the heartbeat signal, or system design constraints.

In a further embodiment of the present invention, the head-mounted display 10 monitors the signal strength of the signal from the controller 20 and compares that with known expected strength for various distances between the controller 20 and the head-mounted display 10. Since signal strength is affected by battery strength, the circuit can adjust for current battery level in the controller 20 and in the head-mounted display 10. In such an embodiment, the controller 20 and the head-mounted display 10 can exchange information relating to battery strength as part of the data communicated between the display wireless communication circuit 24 and the controller wireless communication circuit 22. Circuitry for measuring signal strength and battery strength is within the capability of those knowledgeable in the computing arts and signal communication arts and can include, for example, comparative circuits, digital logic, and the like.

When the distance-monitoring circuitry determines that a pre-determined distance has been exceeded, a variety of range signals are employed to alert a user to the situation. In one embodiment of the present invention, an range signal 62, 64 in either the controller 20 or the head-mounted display 10, or both the controller 20 and the head-mounted display 10, is employed. The range signal 62, 64 is an audible range signal, such as a tone, tone sequence, musical sequence, or other audio signal. In one embodiment of the present invention, the range signal 62, 64 includes words, for example, words that explain the situation or give useful instruction to remedy the situation.

In an alternative embodiment of the present invention, the range signal 62, 64 is presented as information in the head-mounted display 10, for example, as written words that explain the situation or give useful instruction to remedy the situation. Alternatively, flashing lights or other visual cues are employed. In another embodiment, a visual signal is combined with an audio signal. In situations in which the controller 20 is not able to transmit information for display to the user, the range signal 64 and its control is provided in the head-mounted display 10.

In another embodiment of the present invention, the range signal 64 is presented as haptic feedback in the head-mounted display. For example, a control in the head-mounted display 10 can vibrate once or periodically while the controller 20 is outside the specified range. In another embodiment, haptic feedback is combined with a visual signal, an audio signal or both a visual signal and an audio signal.

In an embodiment of the invention, the range signal 64, 62 can include a location of the head-mounted display 10 or the controller 20, or both. The range signal 64, 62 can include a relative location between the head-mounted display 10 and the controller 20 and the relative direction given as a compass direction or indicated with a directional indicator.

In a further embodiment of the present invention, the controller 20 includes a range signal 62 that is initiated by the head-mounted display 10. Alternatively, the head-mounted display 10 includes a range signal 64 that is initiated by the controller 20. The range signal 62, 64 can aid the user in finding one or the other of the head-mounted display apparatus components.

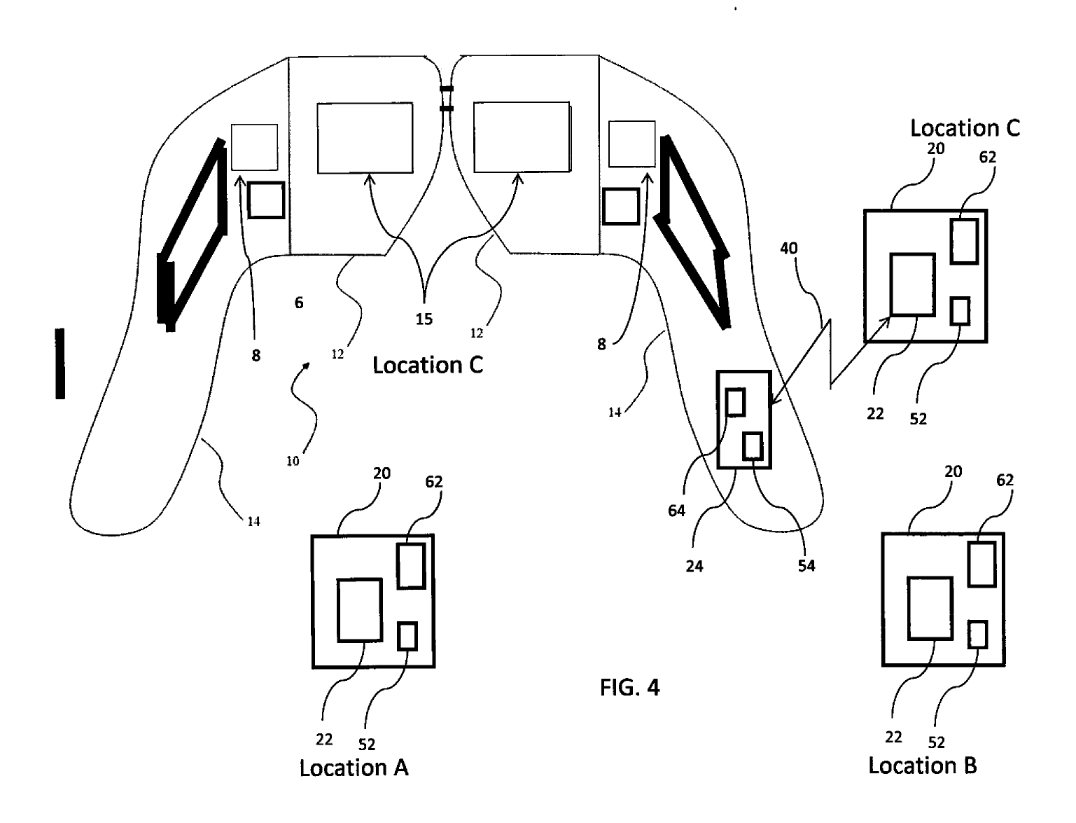

In one embodiment of the present invention, the controller 20 is known to be a temporary controller for the device that is expected to separate from the head-mounted display 10. A temporary controller 20 is part of a separate system and provides control to the head-mounted display 10 only when the head-mounted display 10 is in proximity to the system. Thus, as the head-mounted display 10 is moved from place to place, location-dependent controllers local to the places can provide information to the head-mounted display 10. In this embodiment, the range signal displayed can either be suppressed entirely or displayed is a less intrusive manner. The head-mounted display 10 can record global position satellite (GPS) 72, 74 coordinates and save the coordinates as a location. The head-mounted display 10 can then provide an option to the user to navigate back to the recorded location to return to the controller 20. Referring to FIG. 4, a head mounted display 10 at location C communicates with a controller 20 at the same location C, while controllers 20 at locations A and B do not communicate with the head mounted display 10.

As shown in FIG. 3 and in a further embodiment of the present invention, the viewing area 16 is a switchable viewing element 15 that can each be switched between a transparent state and an information state. The transparent state enables a user of the head-mounted display 10 to see the scene outside the head-mounted display 10 through the switchable viewing elements 15. The information state is opaque and displays information in the switchable viewing elements 15 visible to a user of the head-mounted display 10. Circuitry for producing a control signal for controlling the states of the switchable viewing elements 15 is included together with a controller responsive to the control signal for switching each of the switchable viewing elements 15 between the transparent state and the information state.

In both states, information is projected and viewed by a user, but in the information state, the viewing area 16 is substantially opaque because in the transparent state the viewing area 16 is substantially transparent. Thus, the transparent state enables the user of the head-mounted display 10 to see at least portions of the ambient environment or scene in front of the user. In contrast, the information state enables the user to see projected digital images. The controller 20 of the present invention includes circuitry for producing a control signal for controlling the states of the switchable viewing elements 15. The controller 20 is, for example, a computer, a driver, or a controlling integrated circuit as is known in the computing arts. Circuitry can also be included in the head-mounted display to complement the controller 20 circuitry, particularly to manage the wireless communication and to directly drive the displays or microprojectors 8.

In one embodiment of the present invention, the controller 20 controls each of the switchable viewing elements 15 so that each of switchable viewing elements 15 is semi-transparent. As used herein, a semi-transparent element is an element that transmits some, but not all, of the light incident upon the element. A transparent element transmits substantially all the incident light and an opaque element does not transmit incident light. An opaque element is light-absorbing (e.g. black) or light reflective (e.g. a mirror). A semi-transparent element can transmit various amounts less than all but more than none of the light incident on the element, for example a semi-transparent element can transmit 10%, 30%, 50%, 70%, or 90% of the incident light. In one embodiment of the present invention, the controller 20 controls each of the switchable viewing elements 15 to have any of a plurality of different levels of transparency. For example, the controller 20 can control the switchable viewing elements 15 to be 90%, 50%, or 10% transmissive depending on the control signal provided, for example the strength of an applied electric field to a selected material layer. For the embodiment in which the opaque element is a light-scattering element (e.g. a polymer stabilized liquid crystal layer), light is actually transmitted but the image from the ambient environment is not transmitted because the transmitted light is scattered and as result, the opaque element appears white and the see-through image is not visible.

The invention has been described in detail with particular reference to certain preferred embodiments thereof, but it will be understood that variations and modifications can be effected within the spirit and scope of the invention.

### PARTS LIST

2 user's eye
3 partial reflectors
4 light rays from the microprojector
5 light rays from the ambient environment
7 variable occlusion member
8 microprojector
9 electronics including a controller
10 head-mounted display
11 head-mounted display apparatus
12 lens area or viewing area
13 waveguide
14 ear pieces
15 switchable viewing element
16 viewing area
20 controller
22 controller wireless communication circuit
24 display wireless communication circuit
40 wireless communication channel
52 distance monitoring circuit
54 distance monitoring circuit
62 audible range signal
64 audible range signal
72 GPS
74 GPS

1. A head-mounted display apparatus, comprising:
a head-mounted display, the head-mounted display including a viewing area that displays information to a user of the head-mounted display and including a display wireless communication circuit for receiving wireless control signals;
a controller including a controller wireless communication circuit, wherein the controller controls the information displayed in the head-mounted display by communicating the wireless control signals to the display wireless communication circuit with the controller wireless communication circuit and wherein the controller is physically separate from the head-mounted display; and
a distance-monitoring circuit in the controller or the head-mounted display that monitors the distance between the controller and the head-mounted display and, when the distance between the controller and the head-mounted display is greater than a pre-determined distance, initiating a range signal to the user.

2. The head-mounted display apparatus of claim 1, wherein the distance monitoring circuit has a distance-monitoring circuit component located in the controller and a distance-monitoring circuit component located in the head-mounted display.

3. The head-mounted display apparatus of claim 1, wherein the distance monitoring circuit is included in the display wireless communication circuit, the controller wireless communication circuit, or both the display wireless communication circuit and the controller wireless communication circuit.

4. The head-mounted display apparatus of claim 1, wherein the distance-monitoring circuit includes a propagation delay measurement circuit for measuring the time required for a wireless signal to be communicated from the controller to the head-mounted display or from the head-mounted display to the controller and the distance-monitoring circuit is responsive to the propagation delay measurement circuit to produce the range signal.

5. The head-mounted display apparatus of claim 1, wherein the distance monitoring circuit includes a propagation delay measurement circuit for measuring the time required for a wireless signal to be communicated from the controller to the head-mounted display and back or from the head-mounted display to the controller and back and the distance-monitoring circuit is responsive to the propagation delay measurement circuit to produce the range signal.

6. The head-mounted display apparatus of claim 1, wherein the distance monitoring circuit includes a global positioning satellite (GPS) unit.

7. The head-mounted display apparatus of claim 1, wherein the distance monitoring circuit includes a global positioning satellite unit located in the controller and a global positioning satellite unit located in the head-mounted display.

8. The head-mounted display apparatus of claim 1, wherein the range signal is an audible signal produced in either the controller or produced in the head-mounted display, or produced in both the controller and the head-mounted display.

9. The head-mounted display apparatus of claim 1, wherein the range signal is a haptic signal produced in either the controller or produced in the head-mounted display, or produced in both the controller and the head-mounted display.

10. The head-mounted display apparatus of claim 1, wherein the audible signal includes intelligible words.

11. The head-mounted display apparatus of claim 1, wherein the range signal is presented as information displayed in the head-mounted display.

12. The head-mounted display apparatus of claim 1, wherein the range signal represents a location of the head-mounted display or the controller, or both.

13. The head-mounted display apparatus of claim 1, wherein the range signal represents a relative location between the head-mounted display and the controller.

14. The head-mounted display apparatus of claim 13, wherein the relative location is given as a compass direction or the controller or head-mounted display includes a directional indicator and the relative location is indicated with the directional indicator.

15. The head-mounted display apparatus of claim 1, wherein the controller produces an audible signal that is initiated by the head-mounted display.

16. The head-mounted display apparatus of claim 1, wherein the head-mounted display produces an audible signal that is initiated by the controller.

17. The head-mounted display apparatus of claim 1, wherein the distance-monitoring circuitry initiates the range signal when the controller fails to communicate with the head-mounted display or the head-mounted display fails to communicate with the controller.

18. The head-mounted display apparatus of claim 1, wherein the distance-monitoring circuitry maintains a periodic communication between the controller and the head-mounted display and initiates the range signal when a pre-determined number of communications fail.

19. The head-mounted display apparatus of claim 1, wherein the distance-monitoring circuitry includes a signal strength circuit that measures electromagnetic signal strength.

20. The head-mounted display apparatus of claim 1, wherein the controller is a part of a separate system.

21. The head-mounted display apparatus of claim 1, wherein the controller is a temporary, location-dependent controller.

22. A method for ensuring that separable components of a head-mounted display apparatus are not physically separated, comprising the steps of
providing a head-mounted display, the head-mounted display including a viewing area that displays information to a user of the head-mounted display and including a display wireless communication circuit for receiving wireless control signals;
providing a controller, including a controller wireless communication circuit, wherein the controller controls the information displayed in the head-mounted display by communicating the wireless control signals to the display wireless communication circuit with the controller wireless communication circuit and wherein the controller is physically separate from the head-mounted display;
providing a distance-monitoring circuit in the controller or the head-mounted display that monitors the distance between the controller and the head-mounted display;
monitoring the distance between the controller and the head-mounted display; and
initiating a range signal to the user when the distance is greater than a pre-determined distance.

23. A head-mounted display apparatus, comprising:
a head-mounted display, the head-mounted display including a viewing area that displays information to a user of the head-mounted display and including a display wireless communication circuit for receiving wireless control signals; and
a controller physically separate from the head-mounted display and a controller wireless communication circuit, wherein the controller controls the information displayed in the head-mounted display by causing the wireless control signals to communicate from the control wireless communication circuit to the display wireless communication circuit

24. A head-mounted display system, comprising:
a head-mounted display, the head-mounted display including a viewing area that displays information to a user of the head-mounted display and including a display wireless communication circuit for receiving wireless control signals; and
a plurality of controllers, wherein:
each controller is physically separate from the head-mounted display and located in a different location; and
each controller, including a controller wireless communication circuit, that controls the information displayed in the head-mounted display in the different location, the information communicated by the wireless control signals from the controller wireless communication circuit to the display wireless communication circuit.
